(19) United States
(12) Patent Application Publication
(10) Pub. No.: US 2021/0030104 A1
(43) Pub. Date: Feb. 4, 2021

(54) METHOD FOR PRODUCING A FOOT PART

(71) Applicant: Powerslide GmbH, Bindlach (DE)

(72) Inventor: Matthias Knoll, Bindlach (DE)

(21) Appl. No.: 17/073,364

(22) Filed: Oct. 18, 2020

Related U.S. Application Data
(63) Continuation of application No. PCT/EP2019/059961, filed on Apr. 17, 2019.

(30) Foreign Application Priority Data
Apr. 18, 2018 (DE) 10 2018 109 189.3

(51) Int. Cl. A43B 5/16; A43B 19/00

(52) U.S. Cl. CPC A43B 5/1616; A43B 19/00

(57) ABSTRACT

A method for producing of a foot part for a sports shoe includes the steps of producing a flexible forming part for the shoe collar and shoe sole of the foot part, and joining the edges of the forming part along the shoe sole and around the toe cap. In addition, a foot part for a sports shoe and a sports shoe are provided. The foot part for a sports shoe includes a flexible forming part having edges joined along shoe soles and around a toe cap. The sports shoe includes the foot part.

### CROSS REFERENCE TO RELATED APPLICATIONS

This application is a continuation application of international patent application PCT/EP2019/059961, filed Apr. 17, 2019, designating the United States and claiming priority to German application 10 2018 109 189.3, filed Apr. 18, 2018, and the entire content of both applications is incorporated herein by reference.

### TECHNICAL FIELD

The present disclosure relates to a method for producing a foot part for a sports shoe and a foot part for a sports shoe.

### SUMMARY

It is an object of the present disclosure to facilitate production of a foot part for sports shoes.

This object is achieved by a method for producing a foot part for a sports shoe, a foot part for a sports shoe, and a sports shoe having a foot part, as described herein.

According to a first aspect of the disclosure, the object is achieved by a method for producing a foot part for a sports shoe, such as an inline skate shoe or a bike shoe, having the steps of producing one or several flexible forming parts for the shoe collar and shoe sole; and joining the edges of the forming part(s) along the shoe soles and around the toe cap. The forming part for example comprises foam-like material. The forming part can be produced from a single-layered or multi-layered layer material or by an injection molding method. The heels region of the forming part can sidewardly elongated so that it is adapted to the form of a hard shell and cut-outs (flex cuts) can be omitted. By this method, the production of the sports shoe is facilitated and accelerated, and the quality of the sports shoe is improved.

In an exemplary embodiment of the method, the edges of the forming part are joined by sewing, heating, or gluing. By this for example the technical benefit is achieved that the forming part can be closed in an efficient way in the corresponding regions.

In a further exemplary embodiment of the method, the forming part comprises a layer of polyurethane-foam. In general, the forming part can comprise one or several layers. By this for example the technical benefit is achieved that the foot part can be produced with an efficient cushioning in the inner area.

In a further exemplary embodiment of the method, the forming part is produced by punching out from a layer material or by casting into a blank. The forming part can be casted from polyurethane, ethylene-vinyl acetate-copolymer (EVA), latex or another casting material in an arbitrary form. Casting is realized for example by injection molding.

In a further exemplary embodiment of the method, additional shoe materials, such as an inner part made from EVA-foam or an air cushion system, are soused with the casting material or poured in this. By this other shoe materials can be combined with the casting material and volume and weight can be saved. When being soused or poured these shoe materials are enclosed by the casting material. For this end the shoe materials are placed in a blank before the casting material is infused. Thereby further functional layers can be introduced into the forming part. For example, the stability of the forming part can be increased by pouring in a textile layer as a shoe material.

The shoe materials can also be laminated or glued on the inner or outer side. When a hard-wearing shoe material is arranged on the outer side of the forming part, the produced shoe can be used as an outdoor shoe. The shoe material on the outer side can be an elastic material, such as microfiber, Lycra, polyurethan, a film from thermo plastic polyurethane (TPU-Film), Kevlar or woven materials. The shoe material on the inner side can be an elastic material, such as textile materials from polyester or microfiber.

In a further exemplary embodiment of the method, the forming part can be cast from the casting material, such as polyurethan foam, homogenously with constant hardness.

In a further exemplary embodiment of the method, the forming part can be cast inhomogenously so that different regions of the forming part have a different hardness degree. In this case the sole region of the forming part for example has a higher hardness degree than the region around the ankle or around the heel (dual density). However, the sole region and the heel region can be formed in a single piece.

In a further exemplary embodiment of the method, an air pump system with an inflatable volume is casted into in the forming part. The air pump system comprises the inflatable volume that is formed for example by bag or a balloon. The inflatable volume is enclosed by the casting material. By this for example also the technical benefit is achieved that weight of the shoe is reduced and a thickness and hardness of the forming part can be adjusted according to the pressure in the volume.

By casting for example also the technical benefit is achieved that the forming part can be produced fast and efficiently in an arbitrary form.

In a further exemplary embodiment of the method, the forming part is created by casting the casting material into the hard shell of the shoe. By this for example also the technical benefit is achieved that the hard shell has a stable connection with the forming part. The forming part comprises the hard shell after hardening. The hard shell serves for supporting the foot and/or for producing a mechanical connection with the rail.

In a further exemplary embodiment of the method, the layer material comprises a layer of polyurethane foam. By this for example also the technical benefit is achieved that the forming part can be produced with a cushioning in a simple and swift manner.

In a further exemplary embodiment of the method, the foot part is an inner shoe. By this for example also the technical benefit is achieved that further functional shoe parts can be arranged on the outer side of the foot part.

In a further exemplary embodiment of the method the foot part is glued with a hard shell. By this for example the technical benefit is achieved that the foothold of the sports shoe is improved by the hard shell.

In a further exemplary embodiment of the method, a deepening in the area of the ankle is formed in the forming part. By this for example the technical benefit is achieved that pressure marks in the heel region of the foot are prevented.

In a further exemplary embodiment of the method, in the forming part venting slots or venting openings are created. By this for example the technical benefit is achieved that wear comfort of the sports shoe is increased.

In a further exemplary embodiment of the method, the venting slots or venting openings are formed in the area of the sole. By this for example the technical benefit is achieved that sweating can be prevented.

In a further exemplary embodiment of the method, cutout channels or holes are formed in the heel region of the forming part or in the area in front of the ankle to increase flexibility of the forming part. By this for example the technical benefit is achieved that the forming part can be adapted in simple manner to the shoe last. The cutouts provide additionally for the technical benefit of weight savings and for more ease of movement.

In a further exemplary embodiment of the method, the middle of the forming part is attached to a heels section of the shoe last. By this for example the technical benefit is achieved that the interior space of the sport shoe can be produced with high precision.

In a further exemplary embodiment of the method, the side sections of the forming part are bent around the heels section in direction to the toe of the shoe last. By this for example the technical benefit is achieved that edges of the forming part can be joined more easily.

According to a second aspect of the disclosure, the object is achieved by a foot part for a sport shoe having a flexible forming part, the edges of which are joined along the shoe soles and around the toe cap. The forming part can be a cast forming part, that is formed as discussed above.

In a further exemplary embodiment of the foot part, the forming part comprises on one side an overlapping section for forming a strap on the other side of the forming part.

According to a third aspect of the disclosure, the object is achieved by a sports shoe having a foot part according to the second aspect.

### BRIEF DESCRIPTION OF THE DRAWINGS

The disclosure will now be described with reference to the drawings wherein:

FIG. 1 shows a schematic view of an inline skate;

FIG. 2 shows a top view onto a forming part;

FIG. 3 shows a schematic view of a shoe last;

FIG. 4 shows a schematic view of a shoe last having a forming part attached to;

FIG. 5 shows a further schematic view of the shoe last having side sections of the forming part bended in front direction;

FIG. 6 shows a further schematic view of the forming part having a sewed heel region;

FIG. 7 shows a schematic view the foot part made from the forming part;

FIG. 8 shows a schematic view of another foot part made from the forming part;

FIG. 9 shows a further schematic view of the foot part made from the forming part; and

FIG. 10 shows a block diagram of a method for producing the foot part.

### DESCRIPTION OF EXEMPLARY EMBODIMENTS

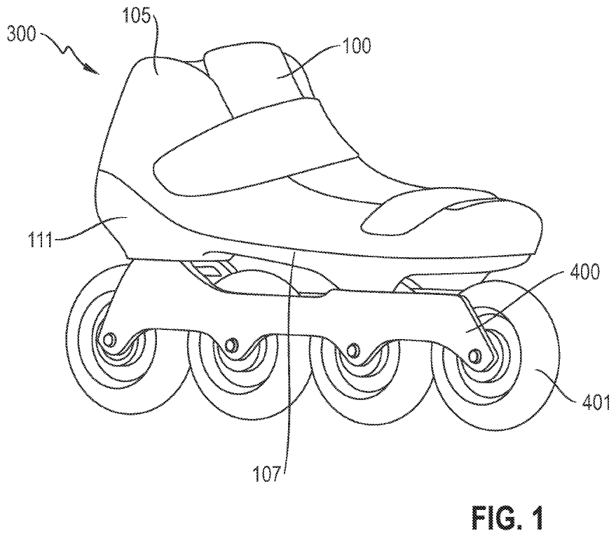

FIG. 1 shows a schematic view of an inline skates 300 as an exemplary embodiment of a sports shoe 300. The inline skate 300 comprises a foot part 100 with a hard shell 111 that together form the sports shoe 300. The hard shell 111 forms the lower part of the sports shoe 300. The sports shoe 300 is attached with the hard shell 111 with a rail 400 having rollers 401. The foot part 100 comprises a shoe collar 105 and a shoe sole 107.

Inline skates 300 are roller skates in which the rollers 401 are arranged in-line. The rail 400 can be made from aluminum and has in subregions a reverse U-shaped profile. Cross holes in the rail 400 serve for mounting the ball bearing rollers 401 with screwable axes.

The sports shoe 300 can also be a bike shoe. In general, the sports shoe 300 can be every sports shoe, in which the foot part 100 can be used.

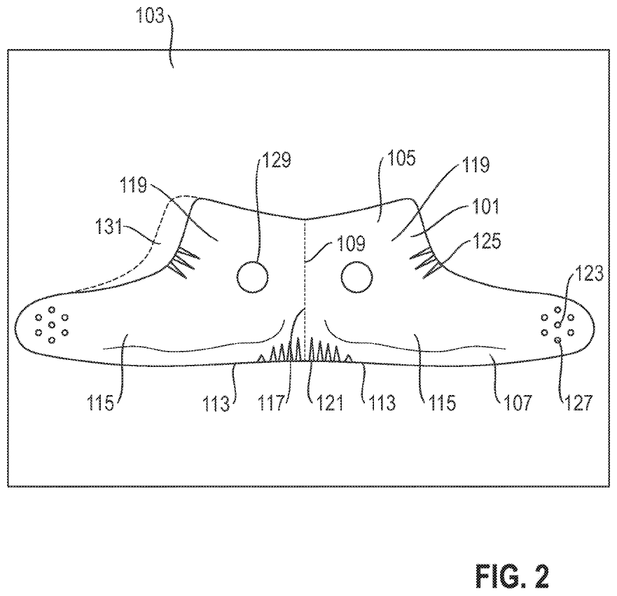

FIG. 2 shows a top view onto a forming part 101 for production of the foot part 100 for the inline skate 300. The forming part 101 is produced from foam-like layer material 103 and has a specially adapted form for building a shoe collar 105 and a shoe sole 107 of the foot part 100. The forming part 101 can be designed in one single piece.

The forming part 101 is essentially axially symmetrical to the middle 109 and comprises two u-shaped or tongue-shaped side sections 115 with a round toe cap 123, from which the shoe sole in combination with the circumjacent foot part 100 is formed. Further, the forming part 101 comprises two middle sections 119 that surround a rearward and lateral heel or calf region of the foot. The side sections 115 protrude laterally with respect to the middle sections 119. The forming part 101 can have on the one side an overlapping section 131 for forming a strap on the other side of the forming part 101. By this the ready-made foot part 100 can be closed on the front side. The overlapping section 131 can be formed on one side of the forming part 101. Due to the overlapping section 131 the forming part 101 has on one side a larger width in the area of the middle section 119 as on the other side. The overlapping section 131 on one side of the forming part 101 overlaps with the other side, when the foot part 100 is ready formed.

The forming part 101 is produced in one piece from a layer material 103 that at least comprises a layer from foam-like plastic material. But the forming part 101 can comprise also two or more parts that are glued, sewed, or welded on the joint.

The layer material 103 comprises for example a layer from cushioning polyurethane foam or another cushioning foam, for example in thickness of 5 mm. The material for the foam can be used in different hardness degrees. When using softer materials, the focus is more on comfort, whereas harder materials rather strive for performance. By a mixture of soft and hard material layers a compromise can be reached with respect to comfort and performance.

The forming part 101 or the layer material 103 can also comprise a layer of ethylene-vinyl-acetate (EVA). The EVA-layer can be produced by EVA-injection molding. The forming part 101 or the layer material 103 can also comprise a gel-cushion material. The layer material 103 or the forming part 101 has for example a thickness of 5 mm. Further, the layer material 103 can comprise further layers, such as a more durable outer layer (liner) for the upper shoe. The upper material for the upper shoe can be heat welded, glued, or cast onto. The more durable outer layer can be made from plastics and serve for supporting the foot or against a wear of the foot part 100. This outer layer can be glued or sewed with the other layers of the forming part 101. In general, the layer material 103 of the forming part 101 can be built in several layers with different functional materials and components. Different materials are glued, sewed, or welded together in several layers for the layer composition.

In the forming part 101 deepenings 129 or embossments can be additionally provided to increase wearing comfort of the sports shoe 300 or to support a certain function of the sports shoe 300. For example, in heels or ankle region 117 deepenings 129 in the forming part 101 can be provided to prevent pressure marks on the foot.

In the area of the sole the forming part 101 can have for example a protrusion to support the arch or a weight function or cushioning function. However, also a separate inner sole can be provided. Also, in the area of the front sole or in a side area of the foot part 100 embossments can be provided in the forming part 101 so that a better adaptation to edges of a hard shell 111 can be achieved. Further embossments in the forming part 101 can be provided for massage or comfort purposes.

The deepening can be stamped or impressed with corresponding tools into the forming part 101. The embossments can be created by adding material on the inner or the outer side of the forming part 101, for example by foaming, sewing, or gluing the corresponding parts.

The forming part 101 is either punched out in the required form from a layer material 103 or cast in the required form, such as in an injection molding method. The forming part 101 can adapt after spatial forming to the anatomical conditions of the foot. The forming part 101 has in addition for example rounded edges 113 or a rounded outer contour so that injuries or irritations of the foot can be prevented, as for example in the area of the stepping-in opening.

Further, the forming part 101 can have at certain positions cutouts 121 for increasing flexibility. For example, in the area of the heel recesses 121 can be provided which cause that the forming part 101 can be bent or adapts to a shoe last in an easier manner. In addition, cutout channels 125 or wholes 127 can be formed to increase flexibility of the forming part.

The cutouts can be V-shaped or U-shaped in their run direction or in cross-section. Such cutouts 121 for increasing the flexibility can be provided on each position, at which a high bendability of the forming part 101 is required.

Further the forming part 101 can be provided with venting openings or venting channels, as for example in the region of the shoe sole. The venting openings or the venting channels enable an air stream in the interior of the foot part 100 and increase the wearing comfort of the foot part 100. These can correspond with corresponding openings in the hard shell 111 and can be provided on corresponding positions. The hard shell 111 is made from firm plastics and can be glued or sewed onto the foot part 100.

The production of the foot part 100 can be performed by using a shoe last. In general, it is also conceivable, to produce the foot part 100 having the forming part 101 without a shoe last. The forming part 101 can for example can be flat and can be put in a casting mold and so being connected with the shell and being brought into shape. Then it is glued in or welded.

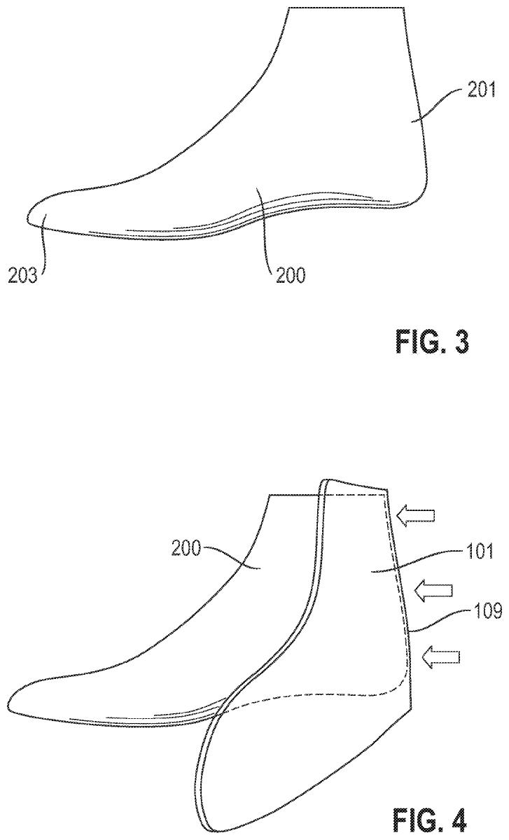

FIG. 3 shows a shoe last 200. The shoe last 200 serves for production of the foot part 100 and represents a spatial imitation of the human foot. The shoe last 200 can be one, two, or in several pieces. The shoe last 200 is the shaping tool that determines the inner dimensions and the outer form of the foot part 100. Foot length, foot width and ball circumference of the shoe last 200 are in a certain proportion to each other. The shoe last 200 has amongst others a heels section 201 and a toe 203. The shoe last 200 can be made from different materials, like wood or plastics.

FIG. 4 shows a schematic view of a shoe last 200 with a forming part 101 attached to. In last-based production of the foot part 100 at first the forming part 101 is attached in the middle 109 onto the heels section 201 of the shoe last 200. Then the further forming of the foot part 100 is performed by adapting the forming part 101 to the shoe last 200.

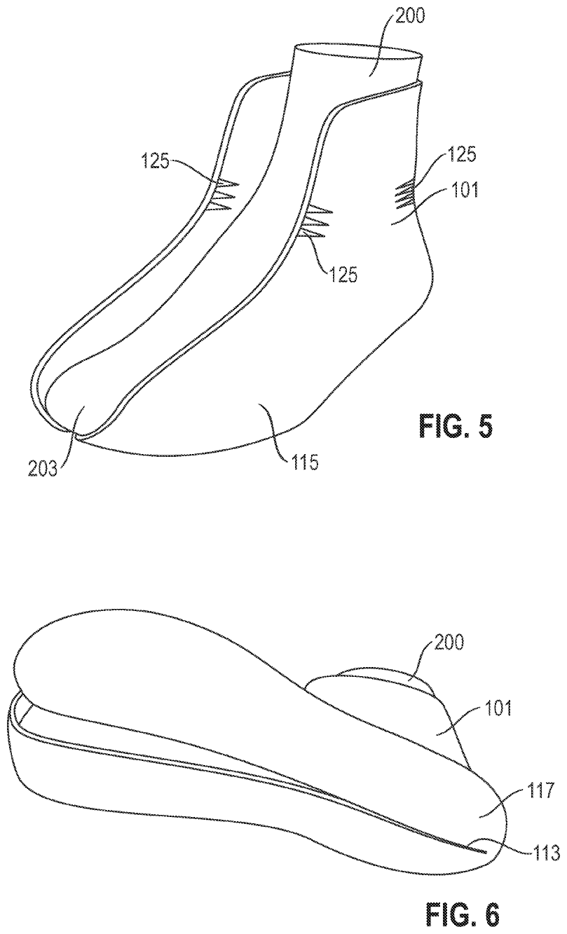

FIG. 5 shows a further schematic view of the shoe last 200 having side sections 115 of the forming part 101 bent in front direction. For further production of the foot part 100 the side sections 115 of the forming part 101 are bent around the heels section 201 into the direction of the toe 203 of the shoe last 200. By this a further forming of the foot part 100 takes place.

FIG. 6 shows a further schematic view the forming part 101 with sewed heels region 117. After the side sections 115 of the forming part 101 are bent around the shoe last 200, the edges 113 of the forming part 101 in the heels region 117 are joined together. This can be done by sewing. However, it is also possible to glue the edges 113 with each other.

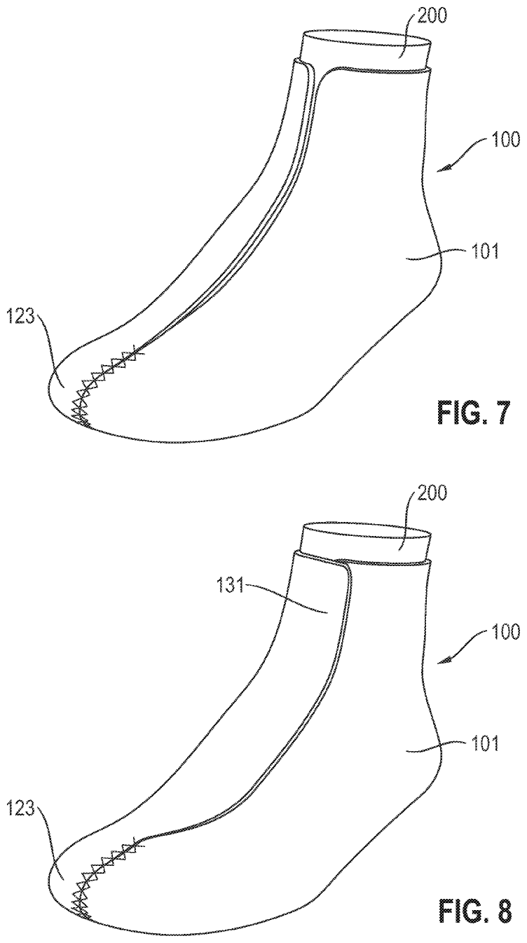

FIG. 7 shows a schematic view the foot part 100 made from the forming part 101. The edges 113 of the forming part 101 are joined along the shoe sole 107 around the toe cap 123. Both sides of the forming part 101 form in the middle of the foot part 100 a stepping-in opening. The forming part 101 for production of the foot part 100 can comprise in the corresponding region an anatomical footbed with an arch. The shoe last 200 still resides within the foot part 100 and will be removed later.

FIG. 8 shows a further schematic view of another foot part 100 made from the forming part 101. In this foot part 100 one side of the forming part 101 is designed with an overlapping section 131. Instead of this the forming part 101 can have the same features as the one shown in FIG. 2.

The overlapping section 131 on the one side of the forming part 101 lies on the other side of the forming part 131 onto the surface. By the overlapping section 131 a strap is created at the front side of the foot part 100. By the strap, an ingress of moisture into the foot part 100 can be prevented and the tongue can be formed integrally within the foot part 100.

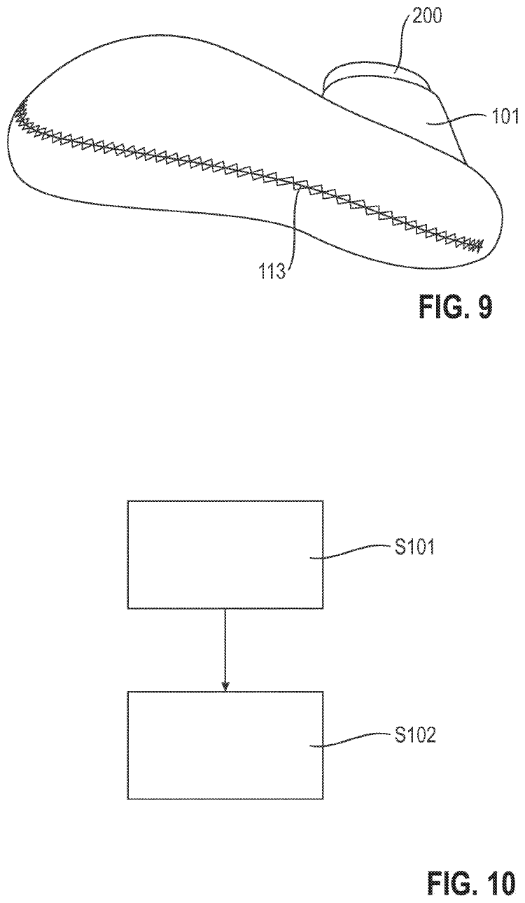

FIG. 9 shows a further schematic view of the foot part 100 made from the forming part 101. In this view it can be seen, how the edges 113 of the forming part 101 are sewed together along the shoe soles 107.

Finally, the shoe last 200 can be removed and the so formed foot part 100 can be glued directly with the hard shell 111 or the collar of the foot part 100 or joined with a hook-and-loop fastener. A tongue of the foot part 100 can be produced in the same way. This is sewed into in the foot part 100 and riveted. The tongue of the foot part 100 can be also sewed, heat-sealed, or glued or connected with a hook-and-loop fastener or a press button. Further, eyelets can be formed in the foot part 100. In this way shoes 100 for inline skates can be produced in a simple manner and with low technical effort from sheet-like layered materials 103.

FIG. 10 shows a block diagram of a production method for an inline skate. In a first step S101 the one-pieced, flexible forming part 101 for the shoe collar 105 and shoe sole 107 of the foot part 100 are created. In a second step S102 the edges 113 of the forming part 101 are joined along the shoe sole 107 and around the toe cap 123. Thereby, the foot part 100 for the sports shoe 300 is created, that can be provided with further components, such as a hard shell, to build the sports shoe 300. In general, the foot part 100 can be used in each sports shoe 300, for which this adapted, like for example bike shoes.

All features discussed and shown with respect to particular embodiments of the disclosure can be provided various combination within the subject-matter according to the disclosure to realize their beneficial effects concurrently.

All method steps can be implemented by means that are adapted to perform the corresponding method step. All functions that are performed by objective features can be a method step in a method.

The scope of the present disclosure is given by the claims and will not be restricted by the features discussed in the description or shown in the figures.

### LIST OF REFERENCE NUMERALS

100 Foot part
101 Forming part
103 Layer material
105 Shoe collar
107 Shoe sole
109 Middle
111 Hard shell
113 Edges
115 Side sections
117 Heel region
119 Middle sections
121 Cutouts
123 Toe cap
125 Cutout channel
127 Holes
129 Deepening
131 Overlapping section
200 Shoe last
201 Heels section
203 Toe
300 Inline skate/Sports shoe
400 Rail
401 Rollers

What is claimed is:

1. A method for producing a foot part for a sports shoe, the method comprising:
producing a flexible forming part for a shoe collar and a shoe sole of the foot part; and
joining edges of the flexible forming part along the shoe sole and around a toe cap.

2. The method according to claim 1, wherein the edges of the flexible forming part are joined by sewing, heating, or gluing.

3. The method according to claim 1, wherein the flexible forming part comprises a layer of polyurethane foam.

4. The method according to claim 1, wherein the flexible forming part is produced by punching out from a layer material or by casting into a blank.

5. The method according to claim 4, wherein the layer material comprises a layer of polyurethane foam.

6. The method according to claim 1, wherein the foot part is an inner shoe.

7. The method according to claim 1, wherein the foot part is glued with a hard shell.

8. The method according to claim 1, further comprising:
forming in the flexible forming part a deepening in an area of an ankle.

9. The method according to claim 1, further comprising:
creating in the flexible forming part venting slots or venting openings.

10. The method according to claim 9, further comprising:
forming venting slots or venting openings in an area of the shoe sole.

11. The method according to claim 1, further comprising:
forming in a heel region of the flexible forming part or in an area in front of ankle cutout channels or holes to increase flexibility of the flexible forming part.

12. The method according to claim 1, further comprising:
attaching a middle of the flexible forming part to a heel section of a shoe last.

13. The method according to claim 1, further comprising:
bending side sections of the flexible forming part around a heels section in a direction to a toe of a shoe last.

14. A foot part for a sports shoe, the foot part comprising:
a flexible forming part having edges joined along shoe soles and around a toe cap.

15. The foot part according to claim 14, wherein the flexible forming part comprises on one side an overlapping section for forming a strap on another side of the flexible forming part.

16. The sports shoe comprising a foot part according to claim 14.
